(19) United States
(12) Patent Application Publication
(10) Pub. No.: US 2026/0302377 A1
(43) Pub. Date: Oct. 1, 2026

(54) LEAK DETECTION SYSTEM FOR BATTERY CELLS

(71) Applicant: GM GLOBAL TECHNOLOGY OPERATIONS LLC, Detroit, MI (US)

(72) Inventors: Mirtha Echeverria KAHN, Bloomfield Hills, MI (US); Raghavendra Saikrishna Keerthi Manda, Northville, MI (US); Jeffery Thomas White, JR., Chesterfield, MI (US); Joseph Phares, Wixom, MI (US)

(21) Appl. No.: 19/089,653

(22) Filed: Mar. 25, 2025

(51) Int. Cl. H01M 10/42; G01M 3/20; G01M 3/22

(52) U.S. Cl. CPC H01M 10/4228; G01M 3/205; G01M 3/229; H01M 10/4285

(57) ABSTRACT

A leakage testing system for battery cells includes a chamber defining a cavity. Separating walls arranged in the cavity to define B cavities configured to receive B battery cells, respectively, where B is an integer greater than one. A vacuum source is configured to selectively evacuate the B battery cells and the B cavities. A trace gas source is configured to selectively fill the B battery cells with a trace gas. A mass spectrometer is configured to individually sample the B cavities and to detect a trace gas level in the B cavities. One or more valves configured to selectively fluidly connect the trace gas source and the vacuum source to vent ports of the B battery cells. B valves in fluid communication with the B cavities. The vacuum source is selectively connected by B valves to the B cavities, respectively.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a leak assessment chamber for battery cells.

Electric vehicles (EVs) such as battery electric vehicles (BEVs), hybrid vehicles, and/or fuel cell vehicles include one or more electric machines and a battery system including one or more battery cells, modules, and/or packs. The battery cells include a battery cell stack including cathode electrodes, anode electrodes, and separators arranged in a predetermined order in a battery cell enclosure. Liquid electrolyte is typically added to the enclosure. The enclosure provides a hermetic seal to contain the electrolyte and gases emitted by the battery cells during charging/discharging.

### SUMMARY

A leakage testing system for battery cells includes a chamber defining a cavity. Separating walls arranged in the cavity to define B cavities configured to receive B battery cells, respectively, where B is an integer greater than one. A vacuum source is configured to selectively evacuate the B battery cells and the B cavities. A trace gas source is configured to selectively fill the B battery cells with a trace gas. A mass spectrometer is configured to individually sample the B cavities and to detect a trace gas level in the B cavities.

In other features, one or more valves configured to selectively fluidly connect the trace gas source and the vacuum source to vent ports of the B battery cells. B valves in fluid communication with the B cavities. The vacuum source is selectively connected by B valves to the B cavities, respectively.

In other features, the mass spectrometer is selectively individually connected by the B valves to the B cavities, respectively. The trace gas source supplies helium gas. The chamber includes a body portion and a lid enclosing the body portion. A controller is configured to control the B valves and the one or more valves.

In other features, the controller is configured to a) control the one or more valves to evacuate the B battery cells; b) control the B valves to evacuate the B cavities; c) after a), control the one or more valves to fill the B battery cells with the trace gas; and d) after c), control the B valves to individually sample the B battery cells.

In other features, B seals are arranged in the B cavities to define B sampling cavities around a portion of the B battery cells. The mass spectrometer samples the B sampling cavities.

A leakage testing system for a battery cell, a chamber defining a cavity; separating walls arranged in the cavity to define T sampling cavities around the battery cell, respectively, where T is an integer greater than one; a vacuum source configured to selectively evacuate the battery cell and the T sampling cavities; a trace gas source configured to selectively fill the battery cell with a trace gas; and a mass spectrometer configured to individually sample the T sampling cavities and to detect a trace gas level in the T sampling cavities.

In other features, one or more valves configured to selectively fluidly connect the trace gas source and the vacuum source to vent port of the battery cell. T valves in fluid communication with the T sampling cavities. The vacuum source is selectively connected by the T valves to the T sampling cavities, respectively. The mass spectrometer is selectively individually connected by the T valves to the T sampling cavities, respectively.

In other features, the trace gas source supplies helium gas. The chamber includes a body portion, a lid portion enclosing the body portion, and a seal between the lid portion and the body portion.

In other features, a controller configured to control the T valves and the one or more valves. The controller is configured to a) control the one or more valves to evacuate the battery cell; b) control the T valves to evacuate the T sampling cavities; c) after a), control the one or more valves to fill the battery cell with the trace gas; and d) after c), control the T valves to individually sample the battery cell to detect the trace gas level.

In other features, M of the T sampling cavities are arranged on a lid portion of the battery cell to isolate leaks on the lid portion of the battery cell, where M is an integer greater than or equal to two.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a vehicle including a battery cell;

FIG. 2 is a perspective view of an example of an enclosure of the battery cell;

FIG. 3 is a functional block diagram of an example of a leak detection system for a plurality of battery cells;

FIG. 4A is a functional block diagram of an example of a leak detection system for a plurality of battery cells according to the present disclosure;

FIG. 4B is a functional block diagram of an example of a controller for the leak detection system according to the present disclosure;

FIG. 4C is a functional block diagram of another example of a leak detection system for a plurality of battery cells according to the present disclosure;

FIG. 5 is a flowchart of a method for detecting leaks in a plurality of battery cells according to the present disclosure; and

FIGS. 6A and 6B are functional block diagrams of examples of leak detection systems for detecting a location of a leak in a single battery cell according to the present disclosure.

In the drawings, reference numbers may be reused to identify similar and/or identical elements.

### DETAILED DESCRIPTION

While a leakage assessment system is described in the context of battery cells for vehicles, the leakage assessment system can be used to test for leakage of other types of battery cells for mobile and/or stationary applications.

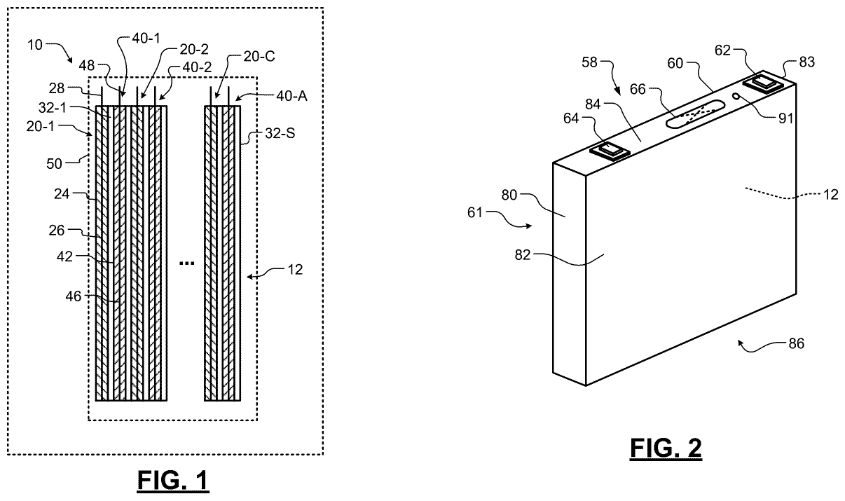

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50 such as a cylindrical, prismatic, or pouch enclosure.

The C cathode electrodes 20-1, 20-2, . . . , and 20-C include cathode active material layers 24 arranged on one or both sides of a cathode current collector 26. The A anode electrodes 40-1, 40-2, . . . , and 40-A include anode active material layers 42 arranged on one or both sides of the anode current collectors 46. In some examples, the A anode electrodes 40 and the C cathode electrodes 20 exchange lithium ions during charging/discharging.

In some examples, the cathode active material layers 24 and/or the anode active material layers 42 comprise coatings including one or more active materials, one or more conductive additives, and/or one or more binder materials that are applied to the current collectors (e.g., using a wet or dry roll-to-roll process), although other manufacturing methods can be used. In some examples, the cathode current collector 26 and/or the anode current collector 46 comprises metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

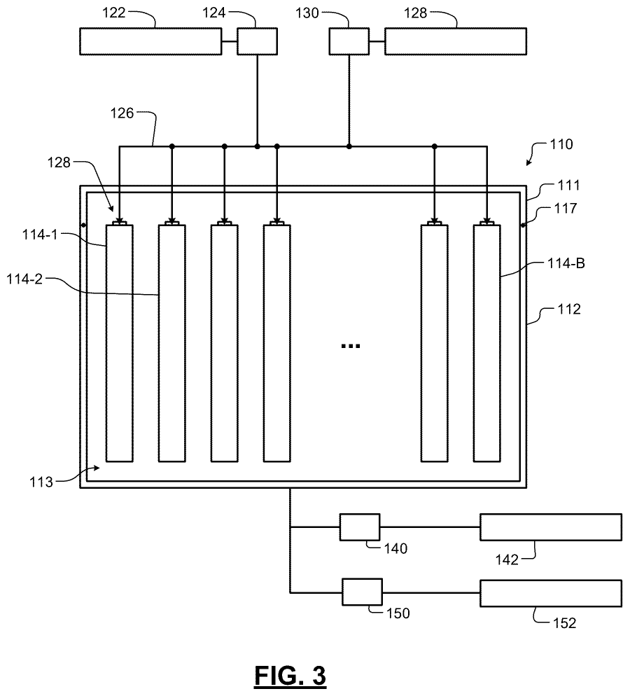

Referring now to FIG. 2, a battery cell 58 includes a battery cell enclosure 60. In some examples, the enclosure 60 has a prismatic shape with rectangular cross-sections in x-, y- and z-axis planes, although other enclosure shapes such as cylindrical or pouch enclosures can be used. In some examples, the battery cell enclosure 60 includes two pieces including an enclosure body 61 and a lid portion 84. The enclosure body 61 includes sides 80 (corresponding to narrow faces), sides 82 (corresponding to wide faces), and a bottom portion 86. In other examples, the lid portion 84 and the bottom portion 86 are attached separately.

The lid portion 84 and optionally the bottom portion 86 are attached to the enclosure body 61 to enclose the top opening and optionally the bottom opening of the enclosure body 61, respectively, to from a hermetic seal. In some examples, the lid portion 84 and/or the bottom portion 86 are welded to the enclosure body 61, although other attachment methods can be used. The battery cell 58 includes external terminals 62 and 64 that pass through the lid portion 84. The battery cell stack 12 of the C cathode electrodes 20, the A anode electrodes 40, and the S separators 32 is arranged in the battery cell enclosure 60.

The external terminals 62 and 64 are connected to external tabs 28 and 48 of the C cathode electrodes 20 and the A anode electrodes 40, respectively. The lid portion 84 (and/or the bottom portion 86) includes a pressure-based vent cap 66 arranged in a vent port. The pressure-based vent cap 66 is configured to release vent gases when pressure within the inner enclosure is greater than a predetermined pressure. The lid portion 84 includes an electrolyte filling port 91.

In some examples, the battery cell stack is manufactured, assembled, and then inserted in the battery cell enclosure during manufacturing. The lid portion is attached to the side walls of the enclosure to enclose the top opening. The battery cell enclosures are tested to ensure that the lid portion is attached to the side walls with a hermetic seal.

Referring now to FIG. 3, a leakage assessment chamber 110 includes a lid 111 and a lower body 112 defining an inner cavity 113 configured to receive B battery cells 114-1, 114-2, . . . , and 114-B at the same time, where B is an integer greater than one. In some examples, a seal 117 such as an O-ring is arranged between the lid 111 and the lower body 112 to provide a hermetic seal. Valves 124 and 130 and conduit 126 selectively fluidly connect a trace gas source 122 (e.g., helium (He) or another suitable gas) or a vacuum source 128, respectively, to vent ports of the B battery cells 114-1, 114-2, . . . , and 114-B. A valve 150 selectively connects a vacuum source 152 to the inner cavity 113. A valve 140 selectively connects a mass spectrometer 142 to the inner cavity 113. In some examples, the vacuum sources 128 and 152 are the same.

The B battery cells 114-1, 114-2, . . . , and 114-B are inserted into the inner cavity 113 and the lid 111 is closed. The conduit 126 provides a fluid connection to the vent ports of the B battery cells 114-1, 114-2, . . . , and 114-B. The valve 130 opens, the B battery cells 114-1, 114-2, . . . , and 114-B are evacuated, and the valve 130 closes. The valve 150 opens, the vacuum source 152 evacuates the inner cavity 113, and the valve 150 closes. As can be appreciated, evacuation of the B battery cells 114-1, 114-2, . . . , and 114-B and the inner cavity 113 can be done sequentially, partially overlapping, and/or at the same time. The valve 124 opens, the trace gas source 122 supplies the trace gas to the B battery cells 114-1, 114-2, . . . , and 114-B, and the valve 124 closes. The valve 140 opens and the mass spectrometer 142 detects the presence or absence of the trace gas in the B battery cells 114-1, 114-2, . . . , and 114-B during a predetermined period.

If the trace gas is not detected during the predetermined period, then all of the B battery cells 114-1, 114-2, . . . , and 114-B pass the leak test. However, if the trace gas is detected, one, two or more of the B battery cells 114-1, 114-2, . . . , and 114-B may be the cause of the leak. However, the leakage assessment chamber 110 cannot diagnose which one(s) of the B battery cells 114-1, 114-2, . . . , and 114-B are leaking. As a result, all of the B battery cells 114-1, 114-2, . . . , and 114-B need to undergo additional testing and/or rework. Further, the location of the leak on a failed battery cell is unknown.

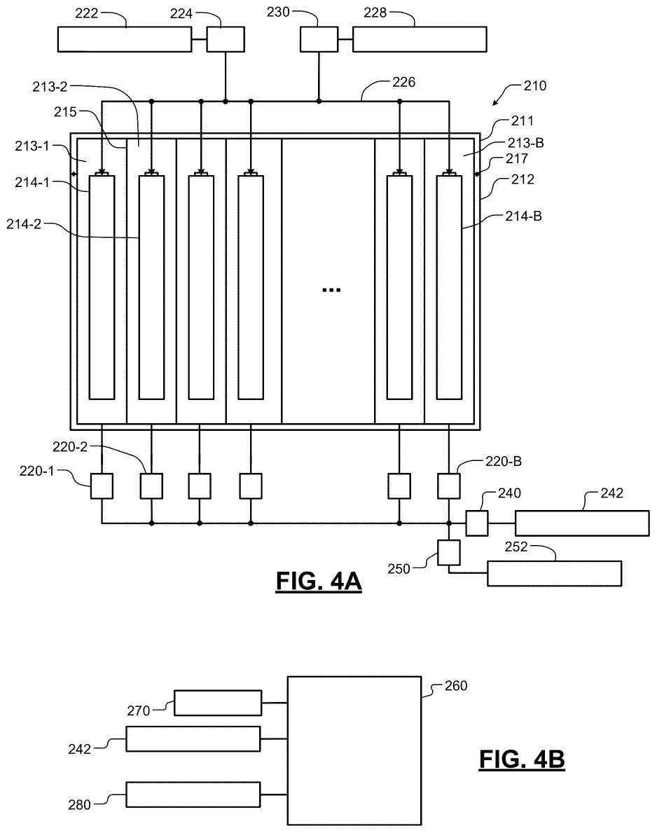

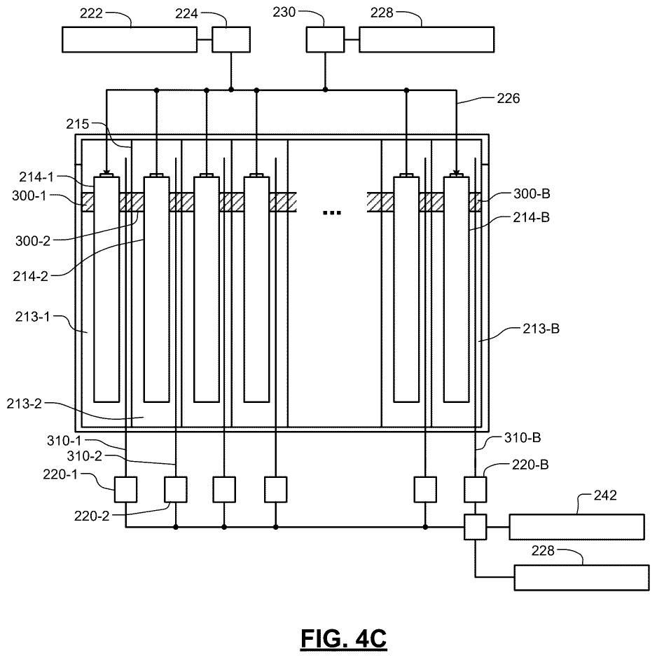

Referring now to FIG. 4, a leakage assessment chamber 210 includes a lid 211, a lower body 212, and a plurality of separating walls 215. The plurality of separating walls 215 define B cavities 213-1, 213-2, . . . , and 213-B that are configured to receive B battery cells 214-1, 214-2, . . . , and 214-B, where B is an integer greater than one. In some examples, a seal 217 such as an O-ring is arranged between the lid 211 and the lower body 212 to provide a hermetic seal. Likewise, the separating walls 215 hermetically seal the B cavities 213-1, 213-2, . . . , and 213-B.

Valves 224 and 230 and conduit 226 selectively fluidly connect a trace gas source 222 (e.g., helium (He) or another suitable gas) or a vacuum source 228, respectively, to vent ports of the B cavities 213-1, 213-2, . . . , and 213-B. B valves 220-1, 220-2, . . . , and 220-B selectively connect the B battery cells 214-1, 214-2, . . . , and 214-B to the vacuum source (e.g., all at the same time) or the mass spectrometer 242 (e.g., individually). A valve 250 selectively connects a vacuum source 252 to the B cavities 213-1, 213-2, . . . , and 213-B. A valve 240 selectively connects a mass spectrometer 242 to the B cavities 213-1, 213-2, . . . , and 213-B.

The B battery cells 214-1, 214-2, . . . , and 214-B are inserted into the inner cavity 213 and the lid 211 is closed. The conduit 226 provides a fluid connection to the vent ports of the B battery cells 214-1, 214-2, . . . , and 214-B. The valve 230 opens, the B battery cells 214-1, 214-2, . . . , and 214-B are evacuated, and the valve 230 closes.

The valve 250 opens, the vacuum source evacuates the B cavities 213-1, 213-2, . . . , and 213-B, and the valve 150 closes. As can be appreciated, evacuation of the B battery cells 214-1, 214-2, . . . , and 214-B and the B cavities 213-1, 213-2, . . . , and 213-B can be done sequentially, partially overlapping, and/or at the same time. The valve 224 opens, the trace gas source 222 supplies the trace gas to the B battery cells 214-1, 214-2, . . . , and 214-B, and the valve 224 closes.

The B valves 220-1, 220-2, and 220-B are opened (e.g., one at a time) and the valve 240 opens to allow the mass spectrometer 242 to detect the presence or absence of the trace gas in the B battery cells 214-1, 214-2, . . . , and 214-B during B predetermined periods, respectively. As can be appreciated, a purge step may be performed between samples. In other examples, S mass spectrometers can be used to reduce cycle times, where S is less than or equal to B. For example, S=2 mass spectrometers can be used to reduce the mass spectrometer sampling period by one-half.

If the trace gas is not detected during the predetermined period, then the corresponding one of the B battery cells 214-1, 214-2, . . . , and 214-B passes the leak test. However, if the trace gas is detected, the corresponding one of the B battery cells 214-1, 214-2, . . . , and 214-B needs to undergo additional leakage testing to identify the location of the leak.

Referring now to FIG. 4B, a controller 260 is configured to control the timing of opening and closing of valves 270 (including the B valves 220-1, 220-2, . . . , 220-B, the valve 240, the valve 250, the valve 224, and/or the valve 230). The valves 270 control evacuation of the B battery cells 214-1, 214-2, . . . , and 214-B and/or the B cavities 213-1, 213-2, . . . , and 213-B, filling of the B battery cells 214-1, 214-2, . . . , and 214-B and/or the B cavities 213-1, 213-2, . . . , and 213-B with the trace gas, and sampling by the mass spectrometer 242. In some examples, the controller 260 controls a positioning device 280 to open and close the lid 211, load the B battery cells 214-1, 214-2, . . . , and 214-B, close the lid 211, and/or move the connection to contact and form a seal with the vent ports of the B battery cells 214-1, 214-2, . . . , and 214-B.

Referring now to FIG. 4C, B seals 300-1, 300-2, . . . , and 300-B are optionally arranged in an upper portion of the B cavities 213-1, 213-2, . . . , and 213-B to reduce a sampling volume. In other words, B sampling cavities 313-1, 313-2, . . . , and 313-B are created that correspond to a portion of the B cavities 213-1, 213-2, . . . , and 213-B in a volume around the enclosure area to be tested. The B seals 300-1, 300-2, . . . , and 300-B create a hermetic seal between separating walls 215 of the B battery cells 214-1, 214-2, . . . , and 214-B and the B battery cells 214-1, 214-2, . . . , and 214-B. B conduits 310-1, 310-2, . . . , and 310-B extend from the B valves 220-1, 220-2, . . . , and 220-B to the B sampling cavities 313-1, 313-2, . . . , and 313-B. In this example, the B sampling cavities 313-1, 313-2, . . . , and 313-B surround the lid portions and upper sides of the B battery cells 214-1, 214-2, . . . , and 214-B.

Sampling the B sampling cavities 313-1, 313-2, . . . , and 313-B rather than the B cavities 213-1, 213-2, . . . , and 213-B reduces cycle times by reducing the volume that needs to be evacuated prior to sampling and the volume to be sampled. As can be appreciated, if the bottom portion is attached to the sides (rather than integrated as a single piece with the sides), another seal can be used to define other sampling cavities around the middle and/or bottom of the enclosures.

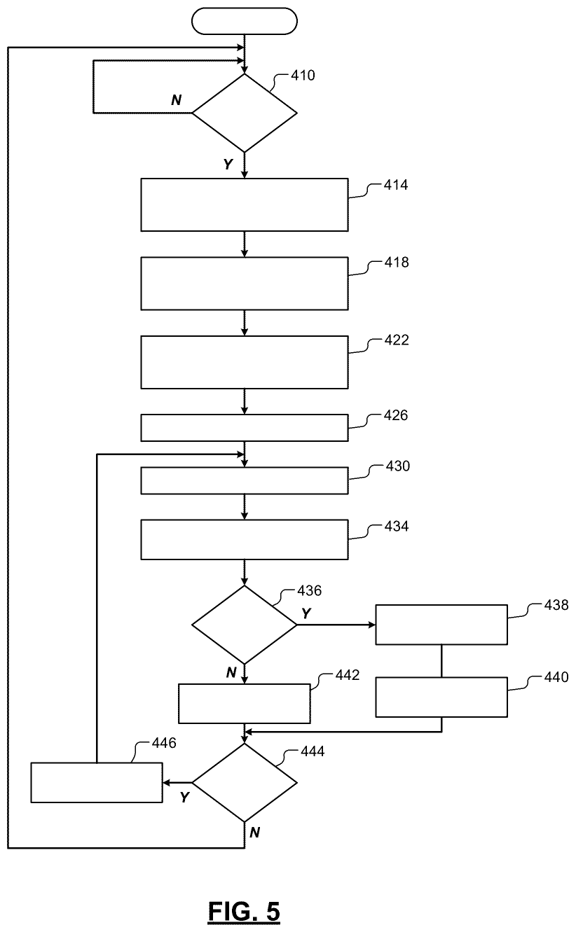

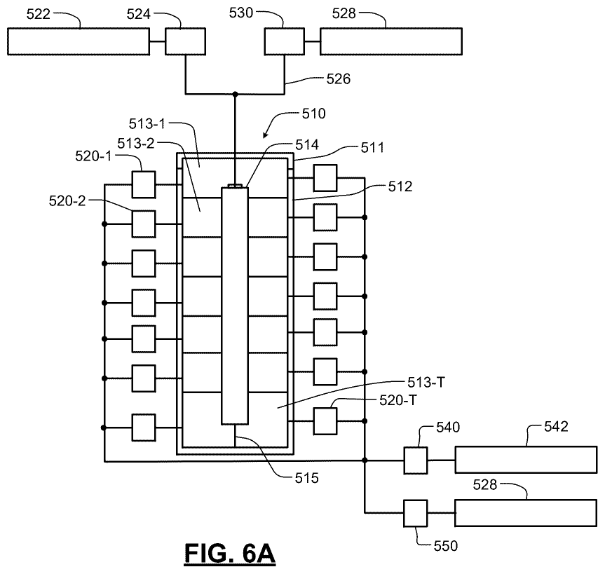

Referring now to FIG. 5, a method for testing B battery cells for leakage is shown. At 410, the method determines whether a leak test needs to be performed. At 414, the method loads the B battery cells into B cavities of a leakage test chamber. At 418, the chamber and the B battery cells are evacuated. At 422, the B battery cells are filled with a trace gas. At 426, B is set equal to 1. At 430, the method opens the B^{th} valve. At 434, the gas from the B^{th} battery cell is sampled by the mass spectrometer.

At 436, the method determines whether the trace gas is sensed. If true, the B^{th} battery cell fails the test and the B^{th} battery cell is moved to a secondary test chamber at 440. If 436 is false, the B^{th} battery cell passes the test. The method continues from 440 and 442 with 444. At 444, the method determines if there are additional battery cells to test. If true, the method increments B at 446 and returns to 430. Otherwise, the method returns to 410.

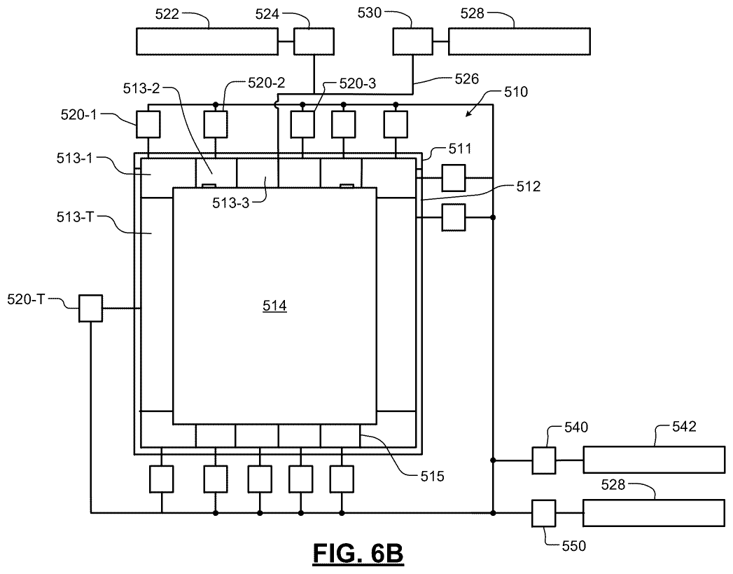

Referring now to FIGS. 6A and 6B, after detecting leakage in one of the battery cells as described above, further testing can be performed to isolate the location of the leak in a single battery cell. In FIG. 6A, a leakage assessment chamber 510 includes a lid 511, a lower body 512, and a plurality of separating walls 515 arranged in horizontal and/or vertical directions around the battery cell to be tested. The plurality of separating walls 515 define T cavities 513-1, 513-2, . . . , and 513-T around the battery cell 514, where T is an integer greater than one. In some examples, a seal (not shown) such as an O-ring is arranged between the lid 511 and the lower body 512 to provide a hermetic seal. The separating walls 515 hermetically seal the T cavities 513-1, 513-2, . . . , and 513-T.

Valves 524 and 530 and conduit 526 selectively fluidly connect a trace gas source 522 or a vacuum source 528, respectively, to the vent port of the battery cell 514. T valves 520-1, 520-2, . . . , and 520-T selectively connect the T cavities 513-1, 513-2, . . . , and 513-T to the vacuum source (e.g., all at the same time to evacuate at the same time) or the mass spectrometer 542 (e.g., one at a time to allow individual testing). Valve 540 selectively connects a mass spectrometer 542 to the T cavities 513-1, 513-2, . . . , and 513-T. A valve 550 selectively connects a vacuum source 552 to the T cavities 513-1, 513-2, . . . , and 513-T.

The battery cell 514 is inserted into the inner cavity 513 and the lid 511 is closed. The conduit 526 provides a fluid connection to the vent port of the battery cell 514. The valve 530 opens, the battery cell 514 is evacuated, and the valve 530 closes. The valve 550 opens, the vacuum source evacuates the T cavities 513-1, 513-2, . . . , and 513-T, and the valve 550 closes. As can be appreciated, evacuation of the battery cell 514 and the T cavities 513-1, 513-2, . . . , and 513-T can be done sequentially, partially overlapping, and/or at the same time. The valve 524 opens, the trace gas source 522 supplies the trace gas to the battery cell 514, and the valve 524 closes.

One of the T valves 520-1, 520-2, and 520-T opens, the valve 540 opens to allow the mass spectrometer 542 to detect the presence or absence of the trace gas one of the T cavities 513-1, 513-2, . . . , and 513-T of the battery cell 514 during one of T predetermined periods, respectively. The process is repeated for other ones of the T cavities 513-1, 513-2, . . . , and 513-T.

In some examples, the mass spectrometer is purged between samples. As can be appreciated, P mass spectrometers can be used to reduce cycle times where P is less than or equal to B. For example, when P=2, the total sampling period of the mass spectrometers can be reduced by one-half. When the trace gas is detected in one of more of the T cavities 513-1, 513-2, . . . , and 513-T, the technicians know where to focus repair efforts.

In FIG. 6A, the separating walls 515 are generally horizontal. However, the separating walls can be horizontal, vertical, and/or combinations thereof. In FIG. 6B, the separating walls 515 are arranged both vertically and horizontally. Some of the T cavities 513-1, 513-2, . . . , and 513-T are arranged along the lid portion of the battery cell 514 to isolate leaks around the electrodes, vent, or other structures in the lid region. For example, M of the T cavities 513-1, 513-2, . . . , and 513-T are arranged to isolate the lid portion of the enclosure, where M is an integer greater than or equal to 2. For example, M=5 in FIG. 6B. In some examples, a similar approach can be used for the bottom portion of the enclosure in cases where the bottom portion is welded to the enclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML 5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A leakage testing system for battery cells, comprising:
a chamber defining a cavity;
separating walls arranged in the cavity to define B cavities configured to receive B battery cells, respectively, where B is an integer greater than one;
a vacuum source configured to selectively evacuate the B battery cells and the B cavities;
a trace gas source configured to selectively fill the B battery cells with a trace gas; and
a mass spectrometer configured to individually sample the B cavities and to detect a trace gas level in the B cavities.

2. The leakage testing system of claim 1, further comprising one or more valves configured to selectively fluidly connect the trace gas source and the vacuum source to vent ports of the B battery cells.

3. The leakage testing system of claim 2, further comprising:
B valves in fluid communication with the B cavities,
wherein the vacuum source is selectively connected by B valves to the B cavities, respectively.

4. The leakage testing system of claim 3, wherein the mass spectrometer is selectively individually connected by the B valves to the B cavities, respectively.

5. The leakage testing system of claim 1, wherein the trace gas source supplies helium gas.

6. The leakage testing system of claim 1, wherein the chamber includes a body portion and a lid enclosing the body portion.

7. The leakage testing system of claim 4, further comprising a controller configured to control the B valves and the one or more valves.

8. The leakage testing system of claim 7, wherein the controller is configured to:
a) control the one or more valves to evacuate the B battery cells;
b) control the B valves to evacuate the B cavities;
c) after a), control the one or more valves to fill the B battery cells with the trace gas; and
d) after c), control the B valves to individually sample the B battery cells.

9. The leakage testing system of claim 3, further comprising B seals arranged in the B cavities to define B sampling cavities around a portion of the B battery cells.

10. The leakage testing system of claim 9, wherein the mass spectrometer samples the B sampling cavities.

11. A leakage testing system for a battery cell, comprising:
a chamber defining a cavity;
separating walls arranged in the cavity to define T sampling cavities around the battery cell, respectively, where T is an integer greater than one;
a vacuum source configured to selectively evacuate the battery cell and the T sampling cavities;
a trace gas source configured to selectively fill the battery cell with a trace gas; and
a mass spectrometer configured to individually sample the T sampling cavities and to detect a trace gas level in the T sampling cavities.

12. The leakage testing system of claim 11, further comprising one or more valves configured to selectively fluidly connect the trace gas source and the vacuum source to vent port of the battery cell.

13. The leakage testing system of claim 12, further comprising:
T valves in fluid communication with the T sampling cavities,
wherein the vacuum source is selectively connected by the T valves to the T sampling cavities, respectively.

14. The leakage testing system of claim 13, wherein the mass spectrometer is selectively individually connected by the T valves to the T sampling cavities, respectively.

15. The leakage testing system of claim 11, wherein the trace gas source supplies helium gas.

16. The leakage testing system of claim 11, wherein the chamber includes a body portion, a lid portion enclosing the body portion, and a seal between the lid portion and the body portion.

17. The leakage testing system of claim 14, further comprising a controller configured to control the T valves and the one or more valves.

18. The leakage testing system of claim 17, wherein the controller is configured to:
a) control the one or more valves to evacuate the battery cell;
b) control the T valves to evacuate the T sampling cavities;
c) after a), control the one or more valves to fill the battery cell with the trace gas; and
d) after c), control the T valves to individually sample the battery cell to detect the trace gas level.

19. The leakage testing system of claim 14, wherein M of the T sampling cavities are arranged on a lid portion of the battery cell to isolate leaks on the lid portion of the battery cell, where M is an integer greater than or equal to two.

20. A leakage testing system for battery cells, comprising:
a chamber defining a cavity;
separating walls arranged in the cavity to define B cavities configured to receive B battery cells, respectively, where B is an integer greater than one;
a vacuum source configured to selectively evacuate the B battery cells and the B cavities;
a trace gas source configured to selectively fill the B battery cells with a trace gas;
a mass spectrometer configured to individually sample the B cavities and to detect a trace gas level in the B cavities;
one or more valves configured to selectively fluidly connect the trace gas source and the vacuum source to vent ports of the B battery cells;
B valves in fluid communication with the B cavities, wherein the vacuum source is selectively connected by B valves to the B cavities, respectively, and wherein the mass spectrometer is selectively individually connected by the B valves to the B cavities, respectively; and
a controller configured to control the B valves and the one or more valves, wherein the controller is configured to:
a) control the one or more valves to evacuate the B battery cells;
b) control the B valves to evacuate the B cavities;
c) after a), control the one or more valves to fill the B battery cells with the trace gas; and
d) after c), control the B valves to individually sample the B battery cells to detect the trace gas level.
